(19) United States
(12) Patent Application Publication
(10) Pub. No.: US 2024/0200681 A1
(43) Pub. Date: Jun. 20, 2024

(54) VALVE UNIT WITH A HOUSING

(71) Applicant: BUERKERT WERKE GmbH & CO. KG, Ingelfingen (DE)

(72) Inventor: Axel HELEI, Ingelfingen (DE)

(21) Appl. No.: 18/535,128

(22) Filed: Dec. 11, 2023

(30) Foreign Application Priority Data
Dec. 16, 2022 (DE) 102022133727.8

(51) Int. Cl. F16K 31/163; F16K 1/12; F16K 31/143; F16K 35/02

(52) U.S. Cl. CPC F16K 31/163; F16K 1/126; F16K 31/143; F16K 35/02; F16K 1/04

(57) ABSTRACT

The disclosure relates to a valve unit having a housing, a fluidic valve drive which has a fluid chamber and a piston delimiting the fluid chamber on one side, a valve spindle coupled to the piston, an elastic restoring element which exerts a force on the valve spindle along the spindle axis, and at least one manually actuatable lever provided on the outside of the valve drive for manually adjusting the valve spindle.

### TECHNICAL FIELD

The disclosure relates to a valve unit comprising a housing.

### BACKGROUND

Valve units have a closing body that is coupled to a valve spindle. The closing body can be adjusted by means of the valve spindle, with an adjustment of the closing body resulting in an opening or closing of the valve unit.

Here, the valve spindle is coupled to a fluidic or an electromechanical valve drive. Alternatively, there are also valve spindles that can be adjusted manually.

If a fluidic or electromechanical valve drive is provided, it may occur that in the event of a failure of the valve drive, the valve unit can no longer be opened or closed.

If a valve unit is provided that features a manual actuation, the valve can only be adjusted by active actuation by hand. The disadvantage with this is that no automatic open-loop control or closed-loop control of the valve unit can be implemented. Moreover, the position of the valve spindle that was last set manually, and thus also that of the closing body, is maintained until it is actively changed again by manual actuation. Depending on the application, this may be undesirable.

Proceeding from this, it is the object of the disclosure to provide a valve unit which circumvents the above-mentioned disadvantages in a simple manner.

### SUMMARY

The valve unit according to the disclosure has a housing, a fluidic valve drive which includes a fluid chamber and a piston which delimits the fluid chamber on one side and is adjustable by fluid in the fluid chamber and a valve spindle coupled to the piston, a closing body arranged at the end of the valve spindle opposite the valve drive, an elastic restoring element which exerts a force on the valve spindle along the spindle axis, and at least one manually actuatable lever which is provided on the outside of the valve drive for manually adjusting the valve spindle and which is adapted to be adjusted from an initial position to an actuating position via an intermediate position, wherein the at least one lever when in an intermediate position or in the actuating position exerts a force on the valve spindle along the spindle axis which counteracts the force of the elastic restoring element, and wherein the at least one lever when in the non-actuated state remains in the initial position and is moved from an intermediate position or the actuating position back to the initial position by the restoring element.

The fundamental idea of the disclosure is to provide a valve unit in which the closing body can be adjusted by the valve spindle both by means of a fluidic valve drive and by a manually actuatable lever.

This means that if the valve drive fails due to a defect or a lack of fluid supply for the fluidic drive, it is still possible to actuate it manually using the at least one lever. The at least one lever can be attached by converting the existing valve, e.g. during maintenance or in the event of a defect. The design also permits easy, e.g. temporary, conversion of existing valve drives from a fluidic drive to the manual variant having levers as shown.

In addition, it is also conceivable for the levers to serve at the same time as a mounting aid for the valve unit in the event that the fluidic drive is not available, since in such cases the closing body needs to be brought to an open position in order to mount the valve unit.

Furthermore, it is ensured by the elastic restoring element that in the case of an adjustment by means of the lever, a restoring force is built up, whereby the non-actuated lever remains in or moves back to its initial position, so that the closing body also assumes its initial position.

Therefore, if the valve unit is neither actuated using the manually actuatable lever nor using the valve drive, the closing body is in a defined position in which the valve is closed or open.

As a result, the closing body of the valve unit can be adjusted manually for a short time by an actuation of the lever. Once the lever is no longer actuated, the restoring element moves the at least one lever and also the valve spindle along with the closing element back to the original position.

One aspect of the disclosure makes provision that a stop is provided which is associated with the valve spindle and by means of which the at least one lever is directly or indirectly mechanically coupled to the valve spindle to displace the latter by swiveling the lever.

The swiveling of the lever here allows a continuous adjustment of the valve spindle together with the closing body.

The stop that is associated with the valve spindle is particularly easy to manufacture. In addition, it constitutes a reliable application point for the lever so that a simple and durable mechanical connection exists between the lever and the valve spindle.

The stop may be provided here on a spindle extension that is coupled to the valve spindle, or on the valve spindle itself.

If the stop is provided on a spindle extension, this allows different spindle extensions to be provided, depending on the application, while the valve spindle remains unchanged.

If the stop is provided directly on the valve spindle itself, the number of components for the valve unit is reduced, which is attended by reduced assembly effort.

The spindle extension may be screwed to the spindle on the face side. The threaded connection allows a universal interface on the valve spindle, so that different spindle extensions can be coupled to the spindle and, in the event of damage to the spindle extensions, they can be replaced at any time.

The spindle extension may include a first extension part which is screwed onto the spindle and extends through the fluid chamber, and a second extension part, wherein the at least one lever when actuated presses axially on the underside in the direction against the stop on the second extension part.

The first extension part may be in the form of a bushing here. The second extension part, on the one hand, constitutes a cost-effective part and, on the other hand, allows a high degree of flexibility. The reason for this is that it can, for example, be mounted and dismounted using a screw without any special tool, so that the manually actuatable lever can be provided on the valve unit as required or can also be removed after the screw has been dismounted, in order, for example, to prevent any unintentional manual actuation or to reduce the installation space occupied by the valve unit. In addition, the lever may also be replaced by a differently dimensioned or shaped lever.

Furthermore, a duct may be provided which extends through the spindle extension and/or the valve spindle and which connects a fluid port located outside the fluid chamber with the fluid chamber.

This allows a hybrid operation, since the valve spindle can be actuated pneumatically or hydraulically and at the same time manually.

Furthermore, the valve unit can thereby also be adjusted mainly by means of the fluidic valve drive, with the levers possibly also moving during the adjustment process without blocking it. In this operating mode, a manual actuation of the valve unit would take place only in exceptional cases by an actuating force acting on the levers.

The at least one lever may include an eccentric surface that is configured to act directly or indirectly on the stop.

The eccentric surface can roll at least partially along the stop when the lever is adjusted, so that wear on the stop and on the eccentric surface is minimized.

Furthermore, the contact areas can be made to be sufficiently small to provide thermal decoupling between the lever and the valve unit.

The eccentric surfaces here may be provided on nose-like projections that extend below the shoulder.

Further, for example, a washer and/or a sliding disk may be provided between the stop and the eccentric surface, on which the eccentric surface is supported and which reduce wear on the eccentric surfaces in that, for example, a softer material is used for it/them.

Furthermore, the washer and/or sliding disk prevents a torque that acts around the spindle axis from the eccentric surfaces from acting on the stop when the levers are actuated.

This is done by the eccentric surfaces sliding along the washer and/or sliding disk when the levers are actuated.

Alternatively, the eccentric surfaces can also cause the washer and/or sliding disk to perform a rotational movement around the valve spindle when the levers are actuated, with this rotational movement not being transmitted to the stop due to a low friction between the stop and the washer and/or sliding disk.

If the stop, for example, is provided on a component screwed to the valve spindle, this inhibits an unintentional loosening of the threaded connection or at least reduces a torque acting on the valve spindle.

The at least one lever may be adapted to be swiveled about a swivel axis that extends radially plane in a spindle axis. This allows the manually actuatable lever to be configured to be particularly space-saving.

Two levers can be provided which are movable in opposite directions and jointly move the valve spindle and are jointly moved by the restoring element. Accordingly, the actuating force that needs to be applied in order to shift the two levers from the initial position to an intermediate position or to the actuating position is divided between the levers. This simplifies actuation and also reduces the force acting on each individual lever. Here it is possible for the levers to be moved away from or toward each other when an actuation occurs.

The two levers may be coupled to each other with an interlocking fit and/or may have complementary coupling structures that define the swivel axis. The form-locking coupling of the levers allows them to be supported against each other during actuation and to act jointly on the stop.

Owing to the complementary coupling structures, no further components need to be provided in order to connect the levers to each other with an interlocking fit, allowing the levers to be installed particularly easily.

The levers can be arranged outside a housing of the valve drive. Furthermore, the swivel axis may be located on the face side of the housing, with the levers extending laterally thereof along opposite sides of the housing.

This constitutes an advantageous positioning so that besides the swivel axis on the face side of the housing the stop may also be provided, which is adapted to be actuated by means of the levers along the valve spindle axis. A particularly space-saving configuration can be achieved by the levers extending along the housing.

Here, the levers may be adapted to swivel toward each other to move from the initial position to the actuating position.

This means that the levers are swiveled toward the housing, for example, and they will have reached the final actuating position shortly before contact with the housing or upon contact with the housing, and all positions between the initial and actuating points constitute intermediate positions.

Furthermore, the fact that the levers swivel toward each other when they are manually adjusted allows them to be engaged around, which makes adjustment particularly easy and allows a measured and controlled actuation.

The complementary coupling structures of the levers are connected to each other with an interlocking fit only in the radial direction of the swivel axis.

Consequently, no interlocking fit is provided between the levers along the swivel axis. The complementary coupling structures can thereby be released from each other by moving the levers in opposite directions along the swivel axis.

This allows a particularly quick mounting and dismounting, since the levers can be simply fitted together or detached. Mounting and dismounting can be carried out without a tool here.

The levers may be formed as identical parts so that it is not necessary to design and manufacture two different levers.

For mounting the levers, they jointly surround the spindle axis, e.g. the spindle extension. To support the levers during axial displacement of the spindle, the levers are clamped between the housing and the stop in the direction of the spindle axis in the actuating position.

The at least one lever may be rotatable relative to the housing about the spindle axis, that is, it can be brought to the perfect actuating position for the user.

### BRIEF DESCRIPTION OF THE DRAWINGS

FIG. 1 shows a valve unit according to the disclosure with manually operable levers in an initial position;

FIG. 2 shows a sectional representation of the valve unit of FIG. 1;

FIG. 3 shows the valve unit of FIG. 2 with manually operable levers in an actuating position;

FIG. 4 shows the detail D of FIG. 1 as a section along the plane IV-IV in a perspective view;

FIG. 5 shows one of the levers in a perspective view; and

FIG. 6 shows two levers in a perspective view.

### DETAILED DESCRIPTION

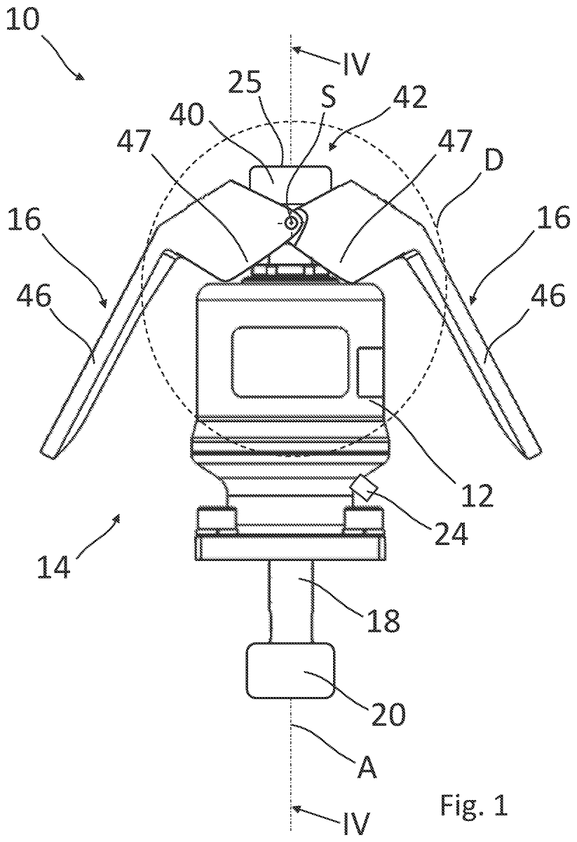

FIG. 1 shows a valve unit 10 having a housing 12. Further provided are a fluidic valve drive 14 and two manually actuatable levers 16, which are in an initial position.

Both the fluidic valve drive 14 and the manually actuatable levers 16 are mechanically coupled to a valve spindle 18 and are used to adjust the latter along a spindle axis A.

A closing body 20 is mounted at the end of the valve spindle 18 opposite the spindle drive. This closing body 20 serves to close or to open a conduit in which, for example, a liquid or a gas is transported, in that it can press against a valve seat.

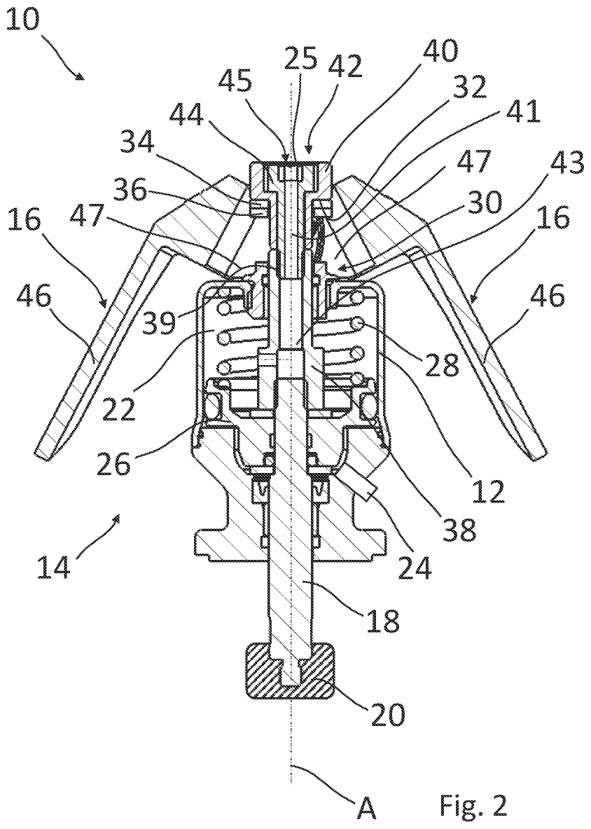

As illustrated in FIG. 2, the valve drive 14 further comprises a fluid chamber 22, which can be filled with a fluid via the ports 24, 25 on either side of a piston 26, which is coupled to the valve spindle 18 and divides the fluid chamber 22 into two sub-chambers.

Furthermore, the piston 26 is acted upon by an elastic restoring element 28 in the form of a helical spring, which is arranged inside the housing 12.

Here, one end of the elastic restoring element 28 is supported from the inside at the face side of the housing 12, and the other end thereof acts on the piston 26.

As a result, the elastic restoring element 28 exerts a force on the piston 26 and thus also on the valve spindle 18, which acts along the spindle axis A and toward the closing body 20.

Furthermore, it can also be seen in FIG. 2 that the valve spindle 18 has a spindle extension 30 associated with it.

The spindle extension 30 is screwed to the valve spindle 18 on the face side and includes a stop 32, by means of which the manually actuatable levers 16 are mechanically coupled to the valve spindle 18. Also, a washer 34 and a sliding disk 36 are provided in the area of the stop.

The spindle extension 30 comprises a first extension part 38 in the form of a bushing, which is screwed to the valve spindle 18 and which extends through the fluid chamber 22 above the piston 26 along the spindle axis A.

The first extension part 38 has an axial stop which axially limits the movement of the valve spindle 18.

The end of the first extension part 38 opposite to the valve spindle 18 is radially guided in a sleeve which is fastened to the fluid chamber 22. Furthermore, the end of the first extension part 38 opposite to the valve spindle 18 protrudes axially from the fluid chamber 22 on the face side in any position of the valve spindle 18 and includes a threaded connection 39.

Moreover, the spindle extension 30 comprises a second, sleeve-like extension part 40, which is fastened by a screw 42. The screw 42 for its part is threaded into the threaded connection 39 of the first extension part 38 on the face side and has a screw head 44, by means of which the second extension part 40 is axially fixed in place, with the stop 32 being formed on the underside thereof. The second extension part 40 and the screw 42 here protrude on the face side from the side of the housing 12 facing away from the closing body 20.

Furthermore, the screw 42 includes a first partial duct 41 in the form of an axial drilled hole, which extends from the port 25 toward the opposite end to open into a second partial duct 43. The second partial duct 43 extends through the interior of the first extension part 38 and through a branch-off extending from the interior of the sleeve into the fluid chamber 22 (more precisely, into the upper partial chamber).

The first and second partial ducts 41, 43 form the duct 45, by which the port 25 is in fluid communication with the fluid chamber 22 (in this case with the upper partial chamber).

The port 25 here could be in the form of a thread in the first partial duct 41 or on the second extension part 40.

The second extension part could also be formed only by the screw 42.

Alternatively, the valve spindle could also be designed to be suitably longer, so that it fully extends through the fluid chamber 22 and protrudes from the housing 12 at the end opposite to the closing body 20, so that the stop 32 is provided on the valve spindle 18 itself.

In both variants, the duct 45 could also be provided.

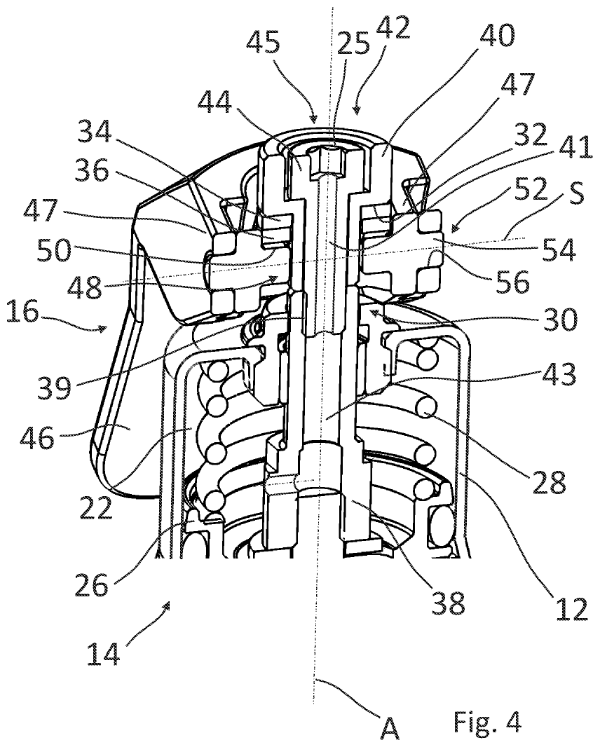

With reference to FIGS. 4 to 6, the structure of the levers 16 and the mechanical coupling between the levers 16 and the valve spindle 18 will now be discussed in more detail.

The levers 16, which are constructed as identical parts, each comprise a handle piece 46, which extends outside the housing 12 along the valve drive 14 and by which one end of the levers is formed.

At the ends facing away from the handle pieces 46, the manually actuatable levers 16 each include two webs 47.

The webs 47 have a direction of extension orthogonal to the longitudinal direction of the handle piece 46 and project laterally from the handle pieces 46, so that they laterally surround the screw 42 together with the handle piece 46 in a U-shape (see in particular FIG. 4).

Furthermore, the webs 47 have projections 48 which extend from the webs 47 in the area in which they enclose the screw 42 towards the latter, so that they are located below the stop 32.

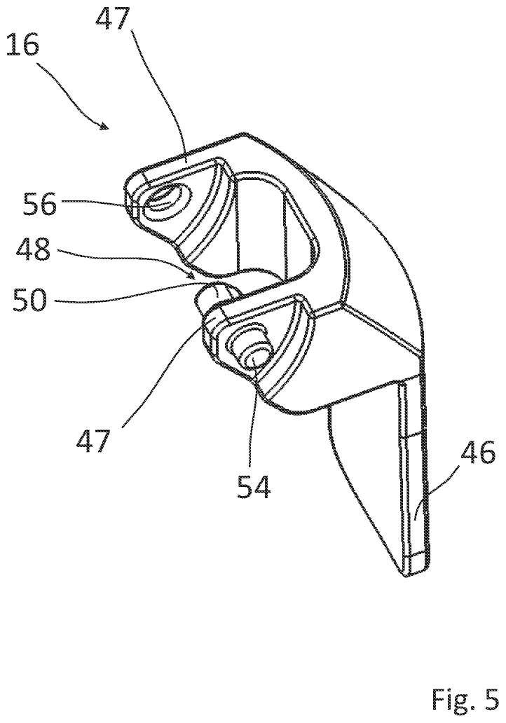

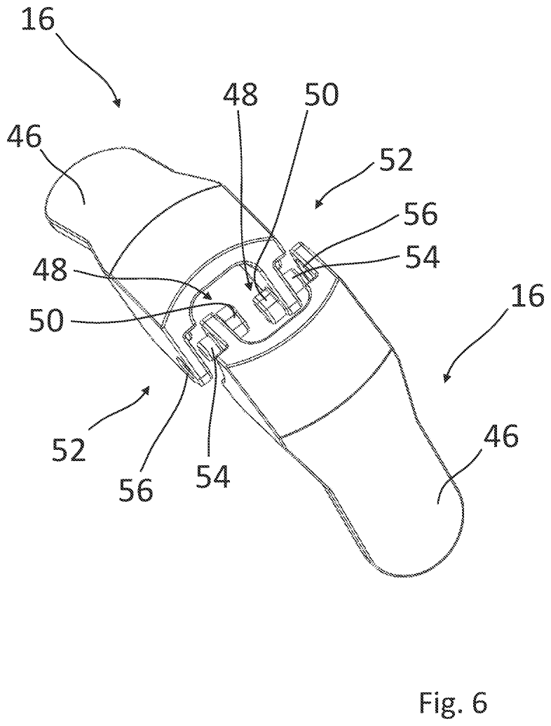

The projections 48 each have eccentric surfaces 50 here (see FIGS. 5 and 6), these eccentric surfaces 50 being provided on the side of the projections facing the stop 32.

Moreover, the levers 16 are coupled to each other with an interlocking fit and have complementary coupling structures 52.

The complementary coupling structures 52 are formed by protruding, opposing studs 54 and by drilled holes 56 within which the studs 54 are arranged. In the respective coupling structures 52, the stud 54 is assigned to one lever 16 and the drilled hole 56 is assigned to the other lever 16.

The coupling structures 52 allow swiveling of the levers 16 and define a swivel axis S which extends in a plane radial to the spindle axis A. The swivel axis S is located on the face side of the housing 12, while the levers 16 extend laterally thereof along opposite sides of the housing 12.

The complementary coupling structures 52 only produce an interlocking fit in the radial direction of the swivel axis S (see FIG. 6).

This means that the levers can be dismounted and mounted without a tool.

As viewed in the direction of the spindle axis A, the two levers 16 completely surround the spindle extension 30 in the area of the webs 47 because the two U-shaped levers 16 complement each other in this area. The levers 16 are also positioned axially in that they are positioned between the sliding disk 36 (top) and the upper side of the end wall of the housing 12 (bottom) and are clamped at least in the actuating position. The webs 47 rest by their lower edges against the end wall of the housing 12.

It is nevertheless possible here for the levers to be movable, i.e. rotatable, about the spindle axis S relative to the housing 12 when in the installed state. In this way, the orientation between the levers 16 and the housing 12 can be freely selected.

As an alternative to the coupling structures 52, the levers 16 may also be coupled to each other by other means, such as, for example, by a threaded joint.

Referring now to FIGS. 2 to 4, it will be discussed below how the manual actuation of the valve unit 10 is effected by means of the levers 16.

The starting point for this is constituted by FIG. 2, in which the levers 16, as already mentioned above, are in the initial position and thus in the non-actuated state.

The levers 16 remain in this very initial position, since the elastic restoring element 28 holds the valve spindle 18 and also the extension parts 38, 40 thereof in position by the force applied to the piston 26.

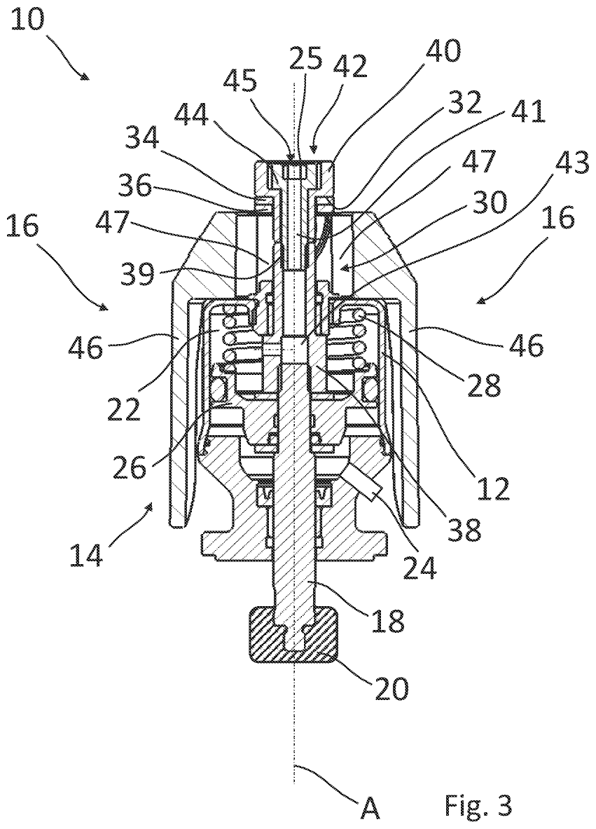

When there is an actuation of the handle pieces 46 of the levers 16 using a force that exceeds the restoring force of the restoring element 28, the levers will move in opposite directions in relation to each other so that the distance between the handle pieces 46 is reduced. In the process, the levers 16 pass from the initial position through an intermediate position extending over the swivel range until they have reached the final actuating position, as shown in FIG. 3. During the swivel movement, the webs 47 are supported on the upper side of the housing 12.

The movement of the levers 16 from the actuating position causes them to jointly move the valve spindle 18 along the valve spindle axis A, exerting a force on the valve spindle 18 in the intermediate positions and also in the actuating position, this force counteracting the force of the elastic restoring element 28 and exceeding it.

When the levers 16 are swiveled, the valve spindle 18 is displaced, on the one hand, by the eccentric surfaces 50 of the projections 48, which upon actuation press axially against the underside of the screw head 44 forming the stop 32 (see in particular FIG. 4). On the other hand, the projections are supported in relation to the housing 12 by the webs 47. As a result, the valve spindle 18 with the closing body 20 is adjusted by means of the screw 42 and the first extension part 38. In the process, the valve unit is opened or closed by actuation of the levers 16.

As an alternative, an axial displacement could also be effected by an appropriately shaped underside of the webs 47 or the axial displacement could be assisted by the eccentric surfaces.

When the levers 16 are no longer actuated or the actuating force decreases to such an extent that the force acting on the valve spindle 18 by the levers 16 falls below that of the elastic restoring element 28, the levers 16 are moved jointly by the restoring element 28 via the intermediate position to the initial position.

In this case, the stop 32 is pressed onto the eccentric surfaces 50 by means of the elastic restoring element 28, so that the handle pieces 46 move away from each other.

As a result, the levers 16 reach their initial position, as shown in FIG. 2, and the valve spindle 18 along with the closing body 20 also returns to its original position.

During the adjustment of the valve unit 10, it is possible for a pressure equalization to occur in the fluid chamber 22 via the ports 24, 25.

Owing to the levers 16, it is possible to open the valve only for a short time.

Because of the small areas of contact with the housing 12 and with the spindle extension, the levers 16 are thermally decoupled to the greatest possible extent from the rest of the valve drive 14.

The design also allows easy, e.g. temporary, conversion of existing valve drives 14 from a fluidic to the manual variant with the levers 16 as shown. Such a short-time installation is advantageous when the valve seat seal is replaced, because the fluid ports are pressureless in this case. The housings 12 usually have a pneumatic or, more generally, fluid connection in the middle of the end wall. This connection is removed without having to dismount the housing. The spindle extension is inserted into the resulting opening and screwed to the valve spindle 18. If required, a seal may also be inserted into the exposed opening to provide a seal against the spindle extension.

In addition to a purely manual actuation of the valve unit 10, a hybrid operation is also conceivable. In such an operation, adjustment of the valve unit 10 would be performed by means of the levers 16 in accordance with the above descriptions. In contrast, however, at the same time the valve spindle 18 would be adjusted by means of the valve drive 14 in assistance of or in addition to manual actuation. To this end, fluid is introduced into and/or drained from the appropriate sub-chamber of the fluid chamber 22 on one or both sides of the piston 26 via the ports 24, 25, so that a piston force acts on the valve spindle 18 by means of the piston.

Furthermore, the valve unit 10 can thereby also be adjusted mainly by means of the fluidic valve drive 14, which would correspond to normal operation. In this case, the levers might possibly also move during the adjustment process without blocking the adjustment. In this operating mode, manual actuation of the valve unit 10 would only take place in exceptional cases.

1. A valve unit comprising a housing, a fluidic valve drive which includes a fluid chamber and a piston which delimits the fluid chamber on one side and is adjustable by fluid in the fluid chamber and a valve spindle coupled to the piston, a closing body arranged at the end of the valve spindle opposite the valve drive, an elastic restoring element which exerts a force on the valve spindle along the spindle axis, and at least one manually actuatable lever which is provided on the outside of the valve drive for manually adjusting the valve spindle and which is adapted to be adjusted from an initial position to an actuating position via an intermediate position, wherein the at least one lever when in an intermediate position or in the actuating position exerts a force on the valve spindle along the spindle axis which counteracts the force of the elastic restoring element, and wherein the at least one lever when in the non-actuated state remains in the initial position and is moved from an intermediate position or the actuating position back to the initial position by the restoring element.

2. The valve unit according to claim 1, wherein a stop is provided which is associated with the valve spindle and by means of which the at least one lever is directly or indirectly mechanically coupled to the valve spindle to displace the latter by swiveling the lever.

3. The valve unit according to claim 2, wherein the stop is provided on a spindle extension that is coupled to the valve spindle.

4. The valve unit according to claim 2, wherein the stop is provided on the valve spindle itself.

5. The valve unit according to claim 3, wherein the spindle extension is screwed to the valve spindle on the face side.

6. The valve unit according to claim 5, wherein the spindle extension includes a first extension part which is screwed onto the spindle and extends through the fluid chamber, and a second extension part, wherein the at least one lever, when actuated, presses axially on the underside in the direction against the stop on the second extension part.

7. The valve unit according to claim 3, wherein a duct is provided which extends through the spindle extension and which connects a fluid port located outside the fluid chamber to the fluid chamber.

8. The valve unit according to claim 4, wherein a duct is provided which extends through the valve spindle and which connects a fluid port located outside the fluid chamber to the fluid chamber.

9. The valve unit according to claim 2, wherein the at least one lever includes an eccentric surface which is configured to directly or indirectly act on the stop.

10. The valve unit according to claim 1, wherein the at least one lever is adapted to be swiveled about a swivel axis extending in a plane radial to the spindle axis.

11. The valve unit according to claim 1, wherein two levers are provided which are movable in opposite directions and which jointly move the valve spindle and are jointly moved by the restoring element.

12. The valve unit according to claim 11, wherein the two levers are coupled to each other with an interlocking fit.

13. The valve unit according to claim 11, wherein the two levers have complementary coupling structures which define the swivel axis.

14. The valve unit according to claim 11, wherein the levers are arranged outside the housing of the valve drive and the swivel axis is located on the face side of the housing, the levers extending laterally of the housing along opposite sides of the housing.

15. The valve unit according to claim 11, wherein the levers are adapted to be swiveled toward each other to move from the initial position to the actuating position.

16. The valve unit according to claim 11, wherein the complementary coupling structures connect the levers to each other with an interlocking fit only in the radial direction of the swivel axis.

17. The valve unit according to claim 11, wherein a stop is provided which is associated with the valve spindle and by means of which the levers are directly or indirectly mechanically coupled to the valve spindle to displace the latter by swiveling the lever, wherein the stop is provided on a spindle extension that is coupled to the valve spindle, and wherein the levers jointly surround the spindle axis and are clamped between the housing and the stop in the direction of the spindle axis in the actuating position.

18. The valve unit according to claim 1, wherein the at least one lever is rotatable about the spindle axis relative to the housing.
